(19) United States
(12) Patent Application Publication
(10) Pub. No.: US 2010/0171840 A1
(43) Pub. Date: Jul. 8, 2010

(54) IMAGE PROCESSING DEVICE, IMAGING APPARATUS, IMAGE BLUR CORRECTION METHOD, AND TANGIBLE COMPUTER READABLE MEDIA CONTAINING PROGRAM

(76) Inventor: SHINTARO YONEKURA, Tokyo (JP)

Correspondence Address: Mr. Jackson Chen, 6535 N. STATE HWY 161, IRVING, TX, 75039, US

(21) Appl. No.: 12/643,124

(22) Filed: Dec. 21, 2009

(30) Foreign Application Priority Data
Jan. 7, 2009 (JP) 2009-001259

(51) Int. Cl. H04N 5/228; G06K 9/40

(52) U.S. Cl. 348/208.4; 382/255; 348/E05.031

(57) ABSTRACT

An image processing apparatus creates a corrected image CP by combining a plurality of captured images P1 to Pn (or a plurality of captured images after performing filtering of at least one of the plurality of captured images P1 to Pn) based on an evaluation result of image blur appearing in the plurality of captured images P1 to Pn. Further, the image processing apparatus repeatedly evaluates the image blur of the plurality of captured images P1 to Pn by using the corrected image CP as a new reference image, and repeatedly creates the corrected image CP based on the evaluation result of the image blur generated repeatedly.

This application is based upon and claims the benefit of priority from Japanese patent application No. 2009-001259, filed on Jan. 7, 2009, the disclosure of which is incorporated herein in its entirety by reference.

### BACKGROUND OF THE INVENTION

1. Technical Field

The present invention relates to an image processing technique that corrects image blur of images captured by an imaging apparatus such as a digital still camera.

2. Background Art

An imaging apparatus converts an electric signal generated by a complementary metal-oxide-semiconductor (CMOS) image sensor, a charge-coupled device (CCD) image sensor or the like into a digital signal and obtains image data. Techniques are known that correct blur appearing in image data (which is referred to hereinafter as image blur) due to user's camera shake or the like. Known as one of such image blur correction techniques is a technique that corrects image blur (i.e. improves the clarity and the sharpness of captured images) by superimposing a plurality of images captured in succession so as to cancel out image blur (cf. e.g. Japanese Unexamined Patent Application Publication Nos. 2007-129476 and 2007-6045).

A correction method disclosed in Japanese Unexamined Patent Application Publication No. 2007-129476 calculates the direction and size (which is referred to hereinafter as a motion vector) of image blur of a plurality of images captured in succession and combines the plurality of captured images by superimposing the images with their pixel positions shifted so as to cancel out the calculated motion vector. An imaging apparatus disclosed in Japanese Unexamined Patent Application Publication No. 2007-129476 thereby obtains an image with reduced image blur.

Further, Japanese Unexamined Patent Application Publication No. 2007-6045 discloses the following correction method. (i) First, select one reference image from a plurality of captured images. A method of selecting a reference image described therein is to select an image with the least camera shake or an image with the highest contrast to be more precise. (ii) Next, calculate a motion vector by comparing the reference image with other captured images and further calculate a point spread function (PSF) with use of the motion vector. The PSF is a function that represents the way light from a single point spreads out, and it contains information about the direction and size of image blur of a plurality of captured images. (iii) Then, perform filtering for correcting image blur on each of the plurality of captured images with use of the calculated PSF. (iv) Finally, combine the plurality of filtered captured images and thereby create a final corrected image. By combining the images, the effect of PSF estimation error can be suppressed.

The image blur correction techniques disclosed in Japanese Unexamined Patent Application Publication Nos. 2007-129476 and 2007-6045 estimate the direction and size (motion vector, PSF etc.) of image blur by comparing a plurality of captured images and combine the plurality of captured images based on the estimation result, thereby obtaining a corrected image. However, the image blur correction techniques disclosed in those documents estimate the direction and size of image blur on the basis of the captured images which include blurry images due to image blur. The present inventor has found that there is a possibility that an error in the estimation result of the direction and size of image blur becomes so large that image blur cannot be corrected sufficiently in the techniques disclosed in Japanese Unexamined Patent Application Publication Nos. 2007-129476 and 2007-6045.

Note that Japanese Unexamined Patent Application Publication No. 2008-22428 discloses a technique that adaptively determines the characteristics of a filter to be used when decoding an image encoded by Joint Photographic Experts Group (JPEG) or the like. Further, Japanese Unexamined Patent Application Publication No. 3-1.60575 discloses a display apparatus that displays an image after performing filtering of image data. However, those documents suggest nothing about how to improve the issue of the image blur correction techniques disclosed in Japanese Unexamined Patent Application Publication Nos. 2007-129476 and 2007-6045.

### SUMMARY

An exemplary object of the invention is to suppress an error in an estimation result of image blur and improve the accuracy of image blur correction when correcting image blur by combining a plurality of captured images.

An image processing apparatus according to an exemplary aspect of the invention includes an image blur evaluation unit and a combining unit. The image blur evaluation unit evaluates image blur appearing in a plurality of captured images. The combining unit creates a corrected image by combining the plurality of captured images or a plurality of captured images after performing filtering of the plurality of captured images based on an evaluation result of the image blur. Further, the image blur evaluation unit repeatedly evaluates the image blur by using the corrected image generated repeatedly as a reference image. The combining unit repeatedly creates the corrected image based on the evaluation result of the image blur generated repeatedly.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a block diagram of an image processing apparatus according to a first exemplary embodiment of the invention;

FIG. 2 is a flowchart showing an execution sequence of image blur correction processing by the image processing apparatus according to the first exemplary embodiment of the invention;

FIG. 3 is a block diagram showing an example of a configuration of an imaging apparatus using the image processing apparatus according to the first exemplary embodiment of the invention;

FIG. 4 is a block diagram of an image processing apparatus according to a second exemplary embodiment of the invention; and

FIG. 5 is a flowchart showing an execution sequence of image blur correction processing by the image processing apparatus according to the second exemplary embodiment of the invention.

### EXEMPLARY EMBODIMENT

Exemplary embodiments of the present invention will be described hereinafter in detail with reference to the drawings. In the drawings, the identical reference symbols denote identical structural elements and the redundant explanation thereof is omitted as appropriate for clarification of the explanation.

### First Exemplary Embodiment

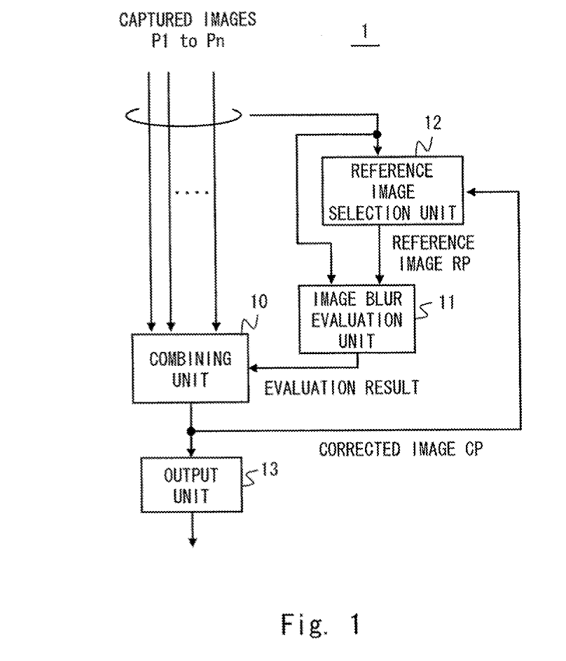

FIG. 1 is a block diagram showing an example of a configuration of an image processing apparatus 1 according to the exemplary embodiment. Referring to FIG. 1, a combining unit 10 receives captured images P1 to Pn, combine them and create a corrected image CP. The image combining by the combining unit 10 is performed by superimposing the captured images P1 to Pn with their pixel positions shifted so as to cancel out image blur appearing in the captured images P1 to Pn. Specifically, the combining unit 10 may combine the images on the basis of a reference image RP in such a way that each of the captured images P1 to Pn overlaps the reference image RP.

The image blur evaluation unit 11 calculates the direction and size of position shift (shift vector) on each of the captured images P1 to Pn which are necessary when the combining unit 10 combines the images. The direction and size of position shift can be obtained from the direction and size of image blur of each of the captured images P1 to Pn with respect to the reference image RP (i.e. motion vector). For example, the image blur evaluation unit 11 may calculate the degree of cross-correlation between the reference image RP and each of the captured images P1 to Pn and determine a shift vector so as to increase the degree of cross-correlation.

The reference image selection unit 12 determines the reference image RP to be supplied to the image blur evaluation unit 11. To be more precise, in an initial state where the corrected image CP which is created by the combining unit 10 does not exist, the reference image selection unit 12 selects the reference image RP from the captured images P1 to Pn. As described above, the reference image RP is used as a reference of the image blur evaluation and the image combining. Therefore, the reference image selection unit 12 preferably selects an image which is estimated to be least fuzzy among the captured images P1 to Pn as the reference image RP. This is because the accuracy of image blur evaluation increases as the image fuzziness of the reference image RP is less, in other words, the sharpness of the reference image RP is higher. The selection of an image with less image fuzziness may be made by selecting an image with the highest contrast, for example.

Further, in a case where the corrected image CP is created by the combining unit 10, the reference image selection unit 12 selects the latest one of the corrected image CP which is created repeatedly by the combining unit 10 as the reference image RP. The image blur evaluation unit 11 thereby repeatedly evaluates image blur by using the corrected image CP as the new reference image RP. Further, the combining unit 10 repeatedly creates the corrected image CP based on the evaluation result of image blur which is generated repeatedly.

The output unit 13 outputs a captured image after image blur correction. For example, the output unit 13 may output the latest corrected image CP at the time point when the number of repetition times of image correction processing which is repeatedly performed by the combining unit 10 and the image blur evaluation unit 11 reaches the predetermined number of times.

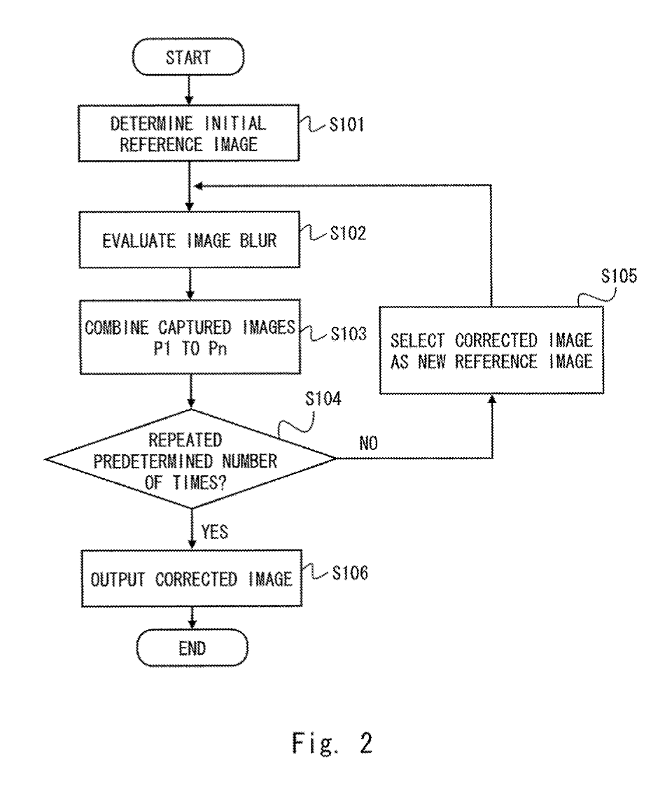

A specific example of an execution sequence of image blur correction by the image processing apparatus 1 is described hereinafter with reference to the flowchart of FIG. 2.

In step S101, the reference image selection unit 12 determines an initial reference image. The initial reference image is selected from the captured images P1 to Pn. As described above, the reference image selection unit 12 may select an image which is estimated to be least fuzzy among the captured images P1 to Pn. Alternatively, the reference image selection unit 12 may select an arbitrary one of the captured images P1 to Pn. For example, the reference image selection unit 12 may select an image which is captured first among the captured images P1 to Pn.

In step S102, the image blur evaluation unit 11 evaluates image blur contained in the captured images P1 to Pn based on the reference image RP.

In step S103, the combining unit 10 combines the captured images P1 to Pn by superimposing them so as to cancel out the image blur contained in the captured images P1 to Pn and thereby creates the corrected image CP.

When the number of times of repetitive creation of the corrected image CP does not reach the predetermined number of times, the latest corrected image CP is selected as the new reference image RP, and the processing of the steps S102 and S103 described above is repeated (steps S104 and S105). After that, when the number of times of repetitive creation of the corrected image CP reaches the predetermined number of times, the output unit 13 outputs the latest corrected image CP as a captured image in which image blur is corrected (step S106).

Completion of repetitive creation of the corrected image CP may be determined by processing time rather than the number of times of processing. Specifically, the image processing apparatus 1. may repeat the repetitive creation of the corrected image CP during allowable processing time and output the latest corrected image CP at the time point when the allowable processing time has elapsed.

As described above, the image processing apparatus 1 according to the exemplary embodiment repeatedly performs the evaluation of image blur and the image combining based on the evaluation result by using the corrected image CP which is obtained by combining the captured images P1 to Pn as a reference image. Because image blur is improved by combining the captured images P1 to Pn, the contrast of the corrected image CP and the sharpness of the edge contained in the corrected image CP are improved compared to the captured images P1 to Pn. By repeatedly evaluating image blur with use of the corrected image CP which is repeatedly generated and gradually becomes closer to a target image (ideal image), it is possible to improve the accuracy of image blur evaluation. Therefore, by repeatedly performing the image combining with use of the corrected image CP as the reference image RP which serves as a reference of superimposition, it is possible to gradually improve the clarity of the corrected image CP.

The evaluation of image blur and the image combining based on the evaluation result which are performed by the image processing apparatus 1 described above may be implemented with use of a semiconductor processing apparatus such as an ASIC, DSP or the like. Further, those processing may be implemented by causing a computer such as a microprocessor to execute a program describing the processing sequence explained with reference to FIG. 2. The control program can be stored in various kinds of storage media or transmitted via communication media. The storage media include a flexible disk, hard disk, magnetic disk, magneto-optical disk, CD-ROM, DVD, ROM cartridge, RAM memory cartridge with battery backup, flash memory cartridge, nonvolatile RAM cartridge and so on. The communication media include a wired communication medium such as telephone lines, a wireless communication medium such as microwave lines and so on, including the Internet.

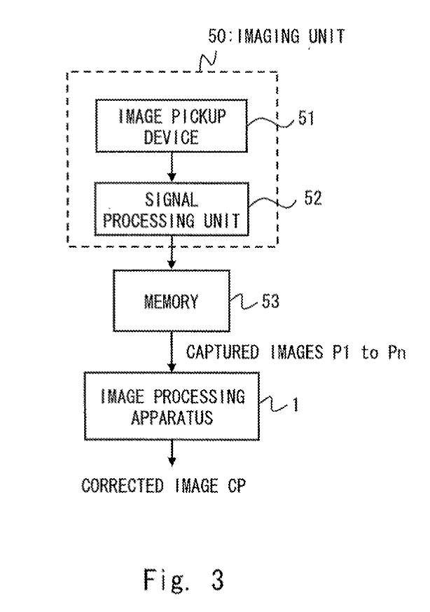

The image processing apparatus 1 according to the exemplary embodiment can be incorporated into electronic equipment such as a digital still camera that includes an image pickup device. FIG. 3 is a block diagram showing an example of a configuration of an imaging apparatus that includes an image pickup device and the image processing apparatus 1. In FIG. 3, an imaging unit 50 includes an image pickup device 51 and a signal processing unit 52. The image pickup device 51 is a CCD image sensor, a CMOS image sensor or the like. The signal processing unit 52 converts analog image data obtained by the image pickup device 51 into digital image data, performs white balance adjustment, interpolation for obtaining an RGB signal for each pixel or the like and outputs RGB image data. In addition to those elements, the imaging unit 50 includes an electronic shutter mechanism that controls exposure time of the image pickup device 51, an aperture control mechanism, a gain control mechanism that adjusts the signal level of a captured image and so on.

A memory 53 stores the captured images P1 to Pn which are captured by the imaging unit 50. The image processing apparatus 1 reads the captured images P1 to Pn from the memory 53 and executes the above-described image blur correction.

### Second Exemplary Embodiment

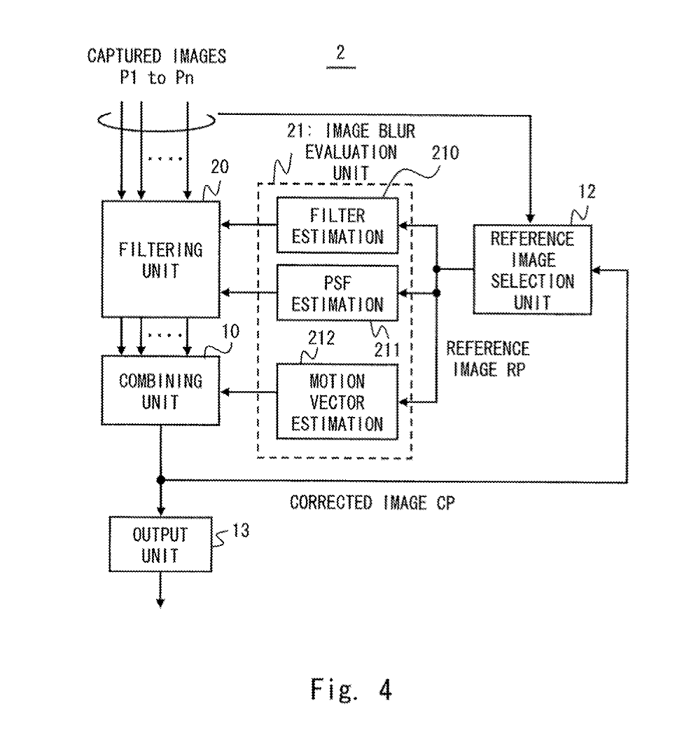

FIG. 4 is a block diagram showing a configuration of an image processing apparatus 2 according to the exemplary embodiment. A filtering unit 20 included in the image processing apparatus 2 executes filtering of the captured images P1 to Pn prior to combining the captured images P1 to Pn. The filtering by the filtering unit 20 is performed repeatedly just like the repetitive creation of the corrected image CP by the combining unit 10.

The image blur evaluation unit 21 generates an evaluation result of image blur which serves as a reference of the image combining in the combining unit 10 just like the above-described image blur evaluation unit 11. Further, the image blur evaluation unit 21 determines filter characteristics to be applied to the filtering unit 20. The determination of the filter characteristics is made on the basis of the latest one of the corrected image CP which is created repeatedly.

In the example of FIG. 4, the image blur evaluation unit 21 includes a filter estimation unit 210, a PSF estimation unit 211 and a motion vector estimation unit 212. The filter estimation unit 210 estimates a filter function (e.g. Wiener filter etc.) for filtering the captured images P1 to Pn based on the reference image RP which is supplied from the reference image selection unit 12. In the estimation of a filter function, a technique that estimates a filter by using an image with less fuzziness as influential information is known. In this technique, the accuracy of filter estimation increases as the fuzziness of an image to be used as influential information is less. In this exemplary embodiment, the reference image selection unit 12 selects the latest corrected image CP as the reference image RP. Because the repeatedly created corrected image CP is an improved image with less image fuzziness than the captured images P1 to Pn, the accuracy of filter function estimation increases by estimating a filter function based on the latest corrected image CP.

The PSF estimation unit 211 estimates a PSF based on the reference image RP which is supplied from the reference image selection unit 12. The estimated PSF is supplied to the filtering unit 20. The filtering unit 20 performs filtering of the captured images P1 to Pn with a filter (Wiener filter etc.) having the inverse characteristics of PSF and thereby improves the degradation (image fuzziness) of the captured images P1 to Pn. In the estimation of PSF, a technique that estimates PSF by using an image with less fuzziness as a reference image is known. In this exemplary embodiment, the latest corrected image CP is selected as the reference image RP, and PSF is estimated based on the latest corrected image CP, so that the accuracy of PSF estimation increases. The filtering unit 20 in the example of FIG. 4 performs filtering of the captured images P1 to Pn by using the filter function and the PSF which are estimated by the filter estimation unit 210 and the PSF estimation unit 211, respectively.

The motion vector estimation unit 212 generates a motion vector that indicates the direction and size of image blur of each of the captured images P1 to Pn with respect to the reference image RP. For example, the motion vector estimation unit 212 may calculate the degree of cross-correlation between the reference image RP and each of the captured images P1 to Pn after filtering by the filtering unit 20 and determine a motion vector based on the degree of cross-correlation. Because image fuzziness is improved in the captured images P1 to Pn after filtering, the accuracy of determining the degree of cross-correlation is higher than that in the case of using the captured images P1 to Pn as they are.

The combining unit 10 combines the captured images P1 to Pn after filtering by superimposition and thereby creates the corrected image CP.

Hereinafter, one of specific examples of a filter function estimation method and a PSF estimation method which are applicable to the filter estimation unit 210 and the PSF estimation unit 211, respectively, are described briefly.

When f(x, y) is ideal image data and g(x, y) is acquired image data (captured image), a relationship between the captured image g(x, y) which is degraded by image blur or the like and the ideal image f(x, y) can be represented by the following expression (1). In the expression (1), h(x, y, x′, y′) indicates PSF, and n(x, y) indicates random noise.

g(x,y)=∫∫f(x′,y′)h(x,y,x′,y′)dx′dy′+n(x,y) Expression (1):

Further, if it is assumed that PSF does not depend on a position within a captured image, the expression (1) can be transformed into the following expression (2). Particularly, in the case of camera shake or the like, the entire image generally moves in the same direction, and the degree of dependence on a position within an image is considered to be small.

g(x,y)=∫∫f(x′,y′)h(x−x′,y−y′)dx′dy′+n(x,y) Expression (2):

If the expression (2) is represented in the spatial frequency domain, the following expression (3) is obtained. In the expression (3), G(u, v), F(u, v), H(u, v) and N(u, v) indicate the spatial frequencies of g(x, y), f(x, y), h(x, y) and n(x, y), respectively. When performing filtering to obtain F(u, v) from the expression (3), the Wiener filter represented by the following expression (4) can be used, for example.

$$\begin{matrix}G ( u , v ) = F ( u , v ) H ( u , v ) + N ( u , v ) & Expression ( 3 ) \\ W ( u , v ) = \frac{H * ( u , v )}{{\vert H ( u , v ) \vert}^{2} + \frac{Pn ( u , v )}{Ps ( u , v )}} & Expression ( 4 )\end{matrix}$$

In the above expressions, H(u, v) indicates the spatial frequency of PSF, H*(u, v) indicates the complex conjugate of the spatial frequency of PSF, and Pn/Ps indicates a ratio of noise and signal power spectrum. In the case of using the Wiener filter represented by the expression (4), information of the reference image RP is input to Ps(u, v). The Wiener filter of the expression (4) is merely an example, and another filter that uses information of the reference image RP may be used.

There are also various techniques for the estimation of H(u, v). One example is a method that estimates H(u, v) by calculation using the following expressions (5) and (6).

$$\begin{matrix}H ( u , v ) = [ KGS \{ \vert G ( u , v ) \vert \} ] \hat{} a ( u , v ) & Expression ( 5 ) \\ a ( u , v ) \approx \frac{\begin{matrix}Ln [ KGS \{ \vert G ( u , v ) \vert \} ] - \\ Ln [ {KF}^{′} S \{ \vert {F}^{′} ( u , v ) \vert \} ]\end{matrix}}{Ln [ KGS \{ \vert G ( u , v ) \vert \} ]} & Expression ( 6 )\end{matrix}$$

In the above expressions, KG and KF′ are constants called scaling parameters. S{ } is a filter called a smoothing filter. F′(u, v) indicates the spatial frequency which is as close as possible to F(u, v). Ln indicates the natural logarithm. In this exemplary embodiment, when performing the estimation of H(u, v) with use of the expressions (5) and (6), information of the reference image RP is input to F′(u, v). Instead of the estimation method that uses the expressions (5) and (6), another PSF estimation method that uses information of the reference image RP may be used.

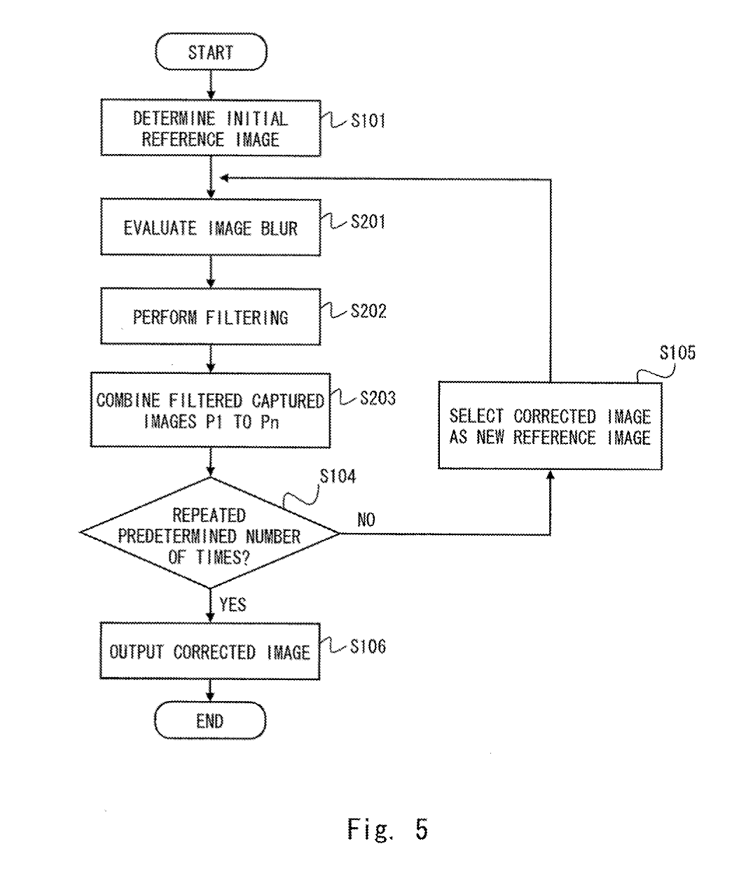

A specific example of an execution sequence of image blur correction by the image processing apparatus 2 is described hereinafter with reference to the flowchart of FIG. 5. In step S201 of FIG. 5, the image blur evaluation unit 21 evaluates image blur contained in the captured images P1 to Pn. Specifically, the filter estimation, the PSF estimation, the motion vector estimation and so on may be performed on the basis of the reference image RP as described above.

In step S202, the filtering unit 20 performs filtering of the captured images P1 to Pn with use of the filter function and the PSF which are estimated by the image blur evaluation unit 21. In step S203, the combining unit 10 combines the captured images P1 to Pn after filtering and thereby creates the corrected image CP.

The processing in the steps S101 and S104 to S106 shown in FIG. 5 are the same as the equivalents described earlier in the flowchart of FIG. 2. Specifically, the filtering unit 20 and the combining unit 10 repeatedly perform the filtering processing and the image combining processing on the captured images P1 to Pn while updating the reference image RP to the latest corrected image CP until the number of times of creating the corrected image reaches the predetermined number of times, and thereby gradually improve the corrected image CP.

As described above, the image processing apparatus 2 performs filtering for improving image fuzziness in each of the captured images P1 to Pn prior to combining the images by superimposition. By superimposing the captured images P1 to Pn whose fuzziness is improved, it is possible to perform the correction of the corrected image CP more effectively.

Further, the image processing apparatus 2 performs the estimation of a motion vector which is necessary for superimposition by using the captured images P1 to Pn whose fuzziness is improved. It is thereby possible to improve the accuracy of motion vector estimation.

Furthermore, when repeatedly executing the filtering by the filtering unit 20, the image processing apparatus 2 determines the filter characteristics by using the latest corrected image CP as the reference image RP. As described above, the accuracy of filter function and PSF estimation increases as the image fuzziness of the reference image RP is lower. Therefore, according to the exemplary embodiment, it is possible to increase the filtering accuracy in stages by repeating the filtering while updating the filter characteristics on the basis of the latest corrected image CP.

The filtering processing and the image combining processing which are performed by the image processing apparatus 2 may be implemented by causing a computer such as DSP, or microprocessor to execute a program describing the processing sequence explained with reference to FIG. 5.

An exemplary advantage according to the above-described embodiments is to suppress an error in an estimation result of image blur and improve the accuracy of image blur correction when correcting image blur by combining a plurality of captured images.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An image processing apparatus comprising:
an image blur evaluation unit that evaluates image blur appearing in a plurality of captured images; and
a combining unit that creates a corrected image by combining the plurality of captured images, or a plurality of captured images after performing filtering of at least one of the plurality of captured images, based on an evaluation result of the image blur, wherein
the image blur evaluation unit repeatedly evaluates the image blur by using the corrected image, which is generated repeatedly, as a reference image, and
the combining unit repeatedly creates the corrected image based on the evaluation result of the image blur generated repeatedly.

2. The image processing apparatus according to claim 1, wherein the image blur evaluation unit evaluates the image blur by using one image selected from the plurality of captured images as the reference image when initially evaluating the image blur in a state where the corrected image does not exist.

3. The image processing apparatus according to claim 1, further comprising:
a filtering unit that repeatedly performs filtering of the plurality of captured images based on the evaluation result of the image blur generated repeatedly, wherein
the combining unit combines a plurality of captured images after filtering by the filtering unit.

4. An imaging apparatus comprising:
the processing apparatus according to claim 1; and
an imaging unit that creates the plurality of captured images.

5. An image blur correction method comprising:
evaluating image blur appearing in a plurality of captured images;
creating a corrected image by combining the plurality of captured images, or a plurality of captured images after performing filtering of at least one of the plurality of captured images, based on an evaluation result of the image blur;
repeatedly executing evaluation of the image blur by using the corrected image, which is generated repeatedly, as a reference image; and
repeatedly executing creation of the corrected image based on the evaluation result of the image blur generated repeatedly.

6. The method according to claim 5, wherein one image selected from the plurality of captured images is used as the reference image when initially evaluating the image blur in a state where the corrected image does not exist.

7. The method according to claim 5, further comprising:
repeatedly performing filtering of the plurality of captured images based on the evaluation result of the image blur generated repeatedly, wherein
the creation of the corrected image is performed by combining a plurality of captured images after filtering.

8. A tangible computer readable medium embodying instructions for causing a computer system to perform an image blur correction method, the method comprising:
evaluating image blur appearing in a plurality of captured images;
creating a corrected image by combining the plurality of captured images, or a plurality of captured images after performing filtering of at least one of the plurality of captured images, based on an evaluation result of the image blur;
repeatedly executing evaluation of the image blur by using the corrected image, which is generated repeatedly, as a reference image; and
repeatedly executing creation of the corrected image based on the evaluation result of the image blur generated repeatedly.

9. The computer readable medium according to claim 8, wherein one image selected from the plurality of captured images is used as the reference image when initially evaluating the image blur in a state where the corrected image does not exist.

10. The computer readable medium according to claim 8, further comprising:
repeatedly performing filtering of the plurality of captured images based on the evaluation result of the image blur generated repeatedly, wherein
the creation of the corrected image is performed by combining a plurality of captured images after filtering.
